(19) United States
(12) Patent Application Publication
(10) Pub. No.: US 2023/0385373 A1
(43) Pub. Date: Nov. 30, 2023

(54) CALCULATOR AND ASSOCIATED METHOD

(71) Applicant: ALIBABA (CHINA) CO., LTD., ZHEJIANG PROVINCE (CN)

(72) Inventors: ZHAOHUI CHEN, Beijing (CN); XUANLE REN, Shanghai (CN); YANHENG LU, Shanghai (CN); JIANSONG ZHANG, Beijing (CN)

(21) Appl. No.: 18/053,524

(22) Filed: Nov. 8, 2022

(30) Foreign Application Priority Data
May 31, 2022 (CN) 202210608229.8

(51) Int. Cl. G06F 17/15; G06F 7/72; G06F 7/76

(52) U.S. Cl. CPC G06F 17/156; G06F 7/727; G06F 7/722; G06F 7/76

(57) ABSTRACT

The present application discloses a calculator and a method thereof. The calculator is configured to accelerate the number-theoretic transformation of a 2^{N}-dimensional polynomial. The calculator includes a first coefficient memory, a second coefficient memory, a twiddle factor memory, a plurality of processing units and a data flow controller. In the odd-number rounds of coefficient computation operations, the processing units perform first calculation procedures to read coefficients from the first coefficient memory for modulo calculation, and perform first writing procedures to write output coefficients to the second coefficient memory. In even-number rounds of coefficient computation operations, the processing units performs second calculation procedures to read coefficients from the second coefficient memory for modulo calculations, and perform second writing procedures to write output coefficients to the first coefficient memory.

### CROSS-REFERENCE TO RELATED APPLICATIONS

This application claims priority of China application No. 202210608229.8, filed on May 31, 2022, which is incorporated by reference in its entirety.

### TECHNICAL FIELD

The present application relates to a calculator and particularly to a calculator capable of accelerating the number-theoretic transformation.

### BACKGROUND

Since artificial intelligence (AI) models, such as the neural network models, can analyze huge amounts of data and extract meaningful information from it, they can be useful for many kinds of industries. However, AI models often require large amounts of expensive computing hardware resources that not every company or research institute can afford; therefore, in order to allow more industries to benefit from the data analysis capabilities of AI, some server providers have started to provide remote computing services. In other words, users can upload the data they want to calculate or analyze to the cloud, and the server providers can provide the service of computing data remotely, and then eventually transmit the calculation results back to the users.

However, the data provided by the user may be confidential and therefore such a service may have security issues. Homomorphic encryption has been introduced to improve the security of data during such services. The homomorphic encryption allows the provider of computing services to perform a specific form of algebraic operation on the encrypted ciphertext, and the encrypted data obtained from the algebraic operation, when decrypted, may be the same as the result of the same algebraic operation on the plaintext data. In other words, the computing service provider can directly use the ciphertext to perform a specific form of computation, such as linear computation, without knowing the contents of the plaintext data, thus improving the security of the service. However, the format of the ciphertext generated by homomorphic encryption is polynomial, so the computation of the ciphertext often involves polynomial multiplication with high complexity, which requires more time or hardware resources for the computing service provider to complete the computation. Therefore, how to improve the computational performance of homomorphic encryption has become an urgent issue in the related field.

### SUMMARY

One purpose of the present disclosure is to disclose a calculator and an associated calculation method to address the foregoing issues.

One embodiment of the present disclosure discloses a calculator, configured to perform number-theoretic transformation on a 2^{N}-dimensional polynomial, wherein N is an integer greater than 1. The calculator includes a first coefficient memory, a second coefficient memory, 2^{M} processing units and a data flow controller. The first coefficient memory is configured to store 2^{N} coefficients of the 2^{N}-dimensional polynomial, in an initial period. The twiddle factor memory is configured to store (2^{N}−1) twiddle factors. The 2^{M} processing units are configured to perform N coefficient computation operations in parallel, wherein M is an integer greater than 1 and smaller than N. The data flow controller is configured to control the 2^{M} processing units to access the addresses of the first coefficient memory, the second coefficient memory and the twiddle factor memory. In each odd-number round of coefficient computation operation, the 2^{M} processing units perform 2^{(N-M-1)} rounds of first calculation procedures to read 2^{N} first coefficients from the first coefficient memory and read at least one first twiddle factor from the twiddle factor memory and perform modulo calculation, and the 2^{M} processing units perform 2^{(N-M-1)} rounds of first writing procedure to write 2^{N} first output coefficients generated during computation in the second coefficient memory. In each even-number round of coefficient computation operation, the 2^{M} processing units perform 2^{(N-M-1)} rounds of second calculation procedure to read 2^{N} second coefficients from the second coefficient memory and read at least one second twiddle factor from the twiddle factor memory and perform modulo calculation, and the 2^{M} processing units perform 2^{(N-M-1)} rounds of second writing procedure to write 2^{N} second output coefficients generated during computation in the first coefficient memory.

Another embodiment of the present disclosure discloses a calculation method. The method includes, in an initial period, storing 2^{N} coefficients of a 2^{N}-dimensional polynomial to a first coefficient memory, and storing (2^{N}−1) twiddle factors corresponding to the 2^{N}-dimensional polynomial to a twiddle factor memory; in a computation period, using the 2^{M} processing units to perform N coefficient computation operations in parallel, including: in each odd-number round of coefficient computation operation, allowing the 2^{M} processing units to perform 2^{(N-M-1)} rounds of first calculation procedures to read 2^{N} first coefficients from the first coefficient memory and at least one first twiddle factor from the twiddle factor memory read and perform modulo calculation, and allowing the 2^{M} processing units to perform 2^{(N-M-1)} rounds of first writing procedure to write 2^{N} first output coefficients generated during computation in the second coefficient memory, and in each even-number round of coefficient computation operation, allowing the 2^{M} processing units to perform 2^{(N-M-1)} rounds of second calculation procedure to read 2^{N} second coefficients from the second coefficient memory and read at least one second twiddle factor from the twiddle factor memory and perform modulo calculation, and allowing the 2^{M} processing units to perform 2^{(N-M-1)} rounds of second writing procedure to write 2^{N} second output coefficients generated during computation in the first coefficient memory. In such case, N is an integer greater than 1, and M is an integer greater than 1 and smaller than N.

In view of the foregoing, the calculator and calculation method of the present disclosure can perform modulo calculations of number-theoretic transformation using multiple processing units in parallel, and can access the data in two coefficient memories according to a specific order, thereby simplifying the wirings between the processing units and coefficient memories and improve the overall computation performance thereof.

### BRIEF DESCRIPTION OF THE DRAWINGS

FIG. 1 is a schematic diagram illustrating a calculator according to one embodiment of the present disclosure.

FIG. 2 illustrates the number-theoretic transformation algorithm according to one embodiment of the present disclosure.

FIG. 3 is a flowchart of a calculation method according to one embodiment of the present disclosure.

FIG. 4 shows the correspondence relationship between the processing unit, the first coefficient memory and the second coefficient memory of FIG. 1.

FIG. 5 to FIG. 8 are schematic diagrams respectively illustrating a processing unit reading a coefficient from a first coefficient storage block in the first to fourth rounds of a first calculation procedure.

FIG. 9 to FIG. 12 are schematic diagrams respectively illustrating a processing unit writing an output coefficient to a second coefficient storage block in the first to fourth rounds of a first writing procedure.

FIG. 13 is a schematic diagram illustrating the twiddle factor memory of FIG. 1 according to one embodiment of the present disclosure.

FIG. 14 is a timing diagram of the processing unit of FIG. 1 reading twiddle factors from the twiddle factor memory.

FIG. 15 is a schematic diagram illustrating the processing unit of FIG. 1 according to one embodiment of the present disclosure.

FIG. 16 is a schematic diagram illustrating the coefficient exchange unit of FIG. 1 according to one embodiment of the present disclosure.

### DETAILED DESCRIPTION

The following disclosure provides various different embodiments or examples for implementing different features of the present disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various embodiments. This repetition is for the purpose of simplicity and clarity and does not in itself dictate a relationship between the various embodiments and/or configurations discussed.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “generally” means within an acceptable standard error of the mean when considered by one of ordinary skill in the art. As could be appreciated, other than in the operating/working examples, or unless otherwise expressly specified, all of the numerical ranges, amounts, values, and percentages (such as those for quantities of materials, duration of times, temperatures, operating conditions, portions of amounts, and the likes) disclosed herein should be understood as modified in all instances by the term “generally.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Here, ranges can be expressed herein as from one endpoint to another endpoint or between two endpoints. All ranges disclosed herein are inclusive of the endpoints, unless specified otherwise.

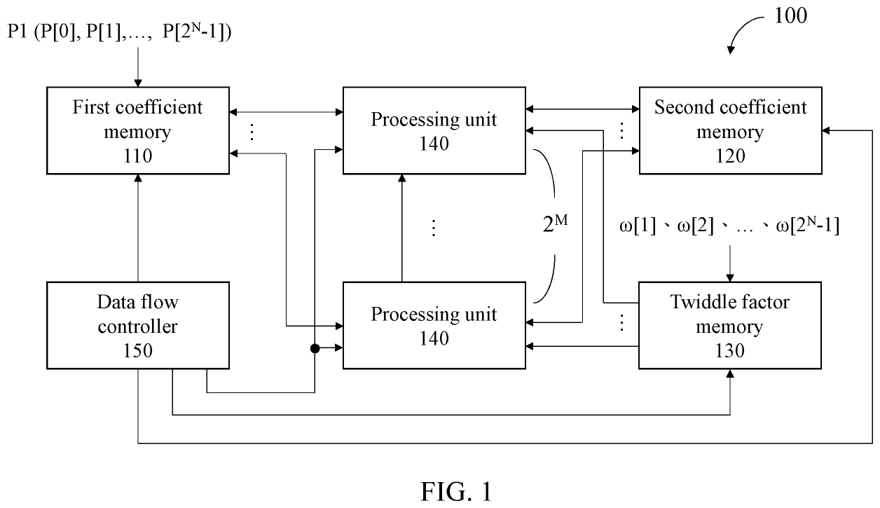

FIG. 1 is a schematic diagram illustrating a calculator 100 according to one embodiment of the present disclosure. The calculator 100 is configured to perform a number-theoretic transformation (NTT) on a 2^{N}-dimensional polynomial P1, wherein, N is an integer greater than 1. The calculator 100 includes a first coefficient memory 110, a second coefficient memory 120, a twiddle factor memory 130, 2^{M} processing units 140 and a data flow controller 150.

The first coefficient memory 110 can store 2^{N} coefficients P[0] to P[2^{N}−1] of the 2^{N}-dimensional polynomial P1 in an initial period, and can store the data outputted by the processing unit 140 during computation. The second coefficient memory 120 can store the data outputted by the processing unit 140 during computation, and the twiddle factor memory 130 can store (2^{N}−1) twiddle factors ω[1] to ω[2^{N}−1] required for performing the number-theoretic transformation on the polynomial P1. Generally, the twiddle factors ω[1] to ω[2^{N}−1] can be calculated in advanced according to the algorithm of the number-theoretic transformation.

Further, 2^{M} processing units 140 can perform the modulo calculation required by the number-theoretic transformation according to the coefficients stored in the first coefficient memory 110 or the second coefficient memory 120 and the twiddle factor stored in the twiddle factor memory 130, and the data flow controller 150 can control the access addresses of the 2^{M} processing units 140 for accessing the first coefficient memory 110, the second coefficient memory 120 and the twiddle factor memory 130 so as to ensure that the 2^{M} processing units 140 can obtain the correct coefficients for performing the computation.

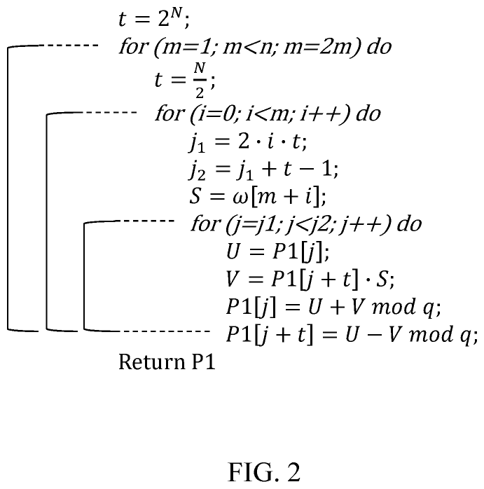

In the present embodiment, the calculator 100 can perform the computation of the number-theoretic transformation using an iterative approach, such as using the algorithm proposed by Cooley and Tukey. FIG. 2 illustrates the number-theoretic transformation algorithm according to one embodiment of the present disclosure. In FIG. 2, q is a predetermined modulus. According to the algorithm shown in FIG. 2, for the 2^{N}-dimensional polynomial P1, the first layer of the for-loop first may be executed for N times; that is, the calculator 100 may perform N rounds of coefficient computation operations to continuously update the coefficients of the polynomial P1. In the second layer of the for-loop, the calculator 100 may first determine the twiddle factors S required for the next modulo calculation in each round and the number of times that the modulo calculation should be performed using the said twiddle factors just determined; then in the third layer of the for-loop, the calculator 100 may select two corresponding coefficients in each round and the twiddle factors S determined in the second layer of the for-loop to perform modulo calculations for updating the coefficients in the polynomial P1.

For example, in the first coefficient computation operation, the twiddle factor ω[1] may be adopted to perform the 2^{(N-1)} round of modulo calculations, and in the second coefficient computation operation, the twiddle factors ω[2] may be adopted to perform the 2^{(N-2)} round of modulo calculations, and the twiddle factors ω[3] may be adopted to perform the 2^{(N-2)} round of modulo calculations, and so on so forth. In such case, in each round of coefficient computation operation, the calculator 100 may perform modulo calculations on 2^{N} input coefficients according to corresponding twiddle factors and generate 2^{N} output coefficients.

In the present embodiment, the 2^{M} processing units 140 can perform modulo calculations of N round of coefficient computation operations in parallel; such as the content calculated in the third layer of the for-loop of FIG. 2. That is, each processing unit 140, in each round, may read 2 coefficients and one twiddle factors to perform a modulo calculation, and thus, in each round of coefficient computation operation, the 2^{M} processing units 140 may perform 2^{(N-M-1)} rounds of calculation procedures in parallel to complete the modulo calculations for all of the 2^{N} coefficients.

Since the total number of coefficients read and generated in each coefficient computation operation is fixed (i.e. the total number is 2^{N}), in the present embodiment, the first coefficient memory 110 and the second coefficient memory 120 can respectively have sufficient space for storing 2^{N} coefficients, and the data flow controller 150 can alternately allowing the processing unit 140 to read the coefficient from one of the first coefficient memory 110 and the second coefficient memory 120, and write the calculation result in the other of the first coefficient memory 110 and the second coefficient memory 120. For example, in the first round of coefficient computation operation, the data flow controller 150 can control the processing unit 140 to read coefficients P[0] to P[2^{N}−1] of the 2^{N}-dimensional polynomial P1 from the first coefficient memory 110, and after performing the computation, control the processing unit 140 to store the computation result in the second coefficient memory 120. Next, in the second round of coefficient computation operation, the data flow controller 150 can control the processing unit 140 to read the coefficient obtained by the previous calculation from the second coefficient memory 120, and after performing the computation, control the processing unit 140 to store the computation result in the first coefficient memory 110 for the use in the next round of coefficient computation operation. In other words, in odd-number rounds of coefficient computation operations, the data flow controller 150 can control the processing unit 140 to read the coefficients from the first coefficient memory 110 to perform computation, and write the computation results to the second coefficient memory 120; whereas in even-number rounds of coefficient computation operations, the data flow controller 150 can control the processing unit 140 to read the coefficients from the second coefficient memory 120 to perform computation, and write the computation results to the first coefficient memory 110.

Further, since the algorithm of number-theoretic transformation is fixed, when performing the number-theoretic transformation on different polynomials, the order in which the coefficients may be accessed in each round should also be fixed and known. In such case, by properly arranging the order of reading and writing of coefficients, it is possible to read coefficients from the first coefficient memory 110 and write the output coefficients to the second coefficient memory 120 according to the same addresses for each odd-number round of coefficient computation operation. Similarly, it is possible to read coefficients from the second coefficient memory 120 and write the output coefficients to the first coefficient memory 110 according to the same addresses for each even-number round of coefficient computation operation. In this way, the access operations of 2^{M} processing units on the first coefficient memory 110 and the second coefficient memory 120 can be simplified, thereby simplifying the operation of the calculator 100 and improving the performance of the 2^{M} processing units 140 when performing parallel computations.

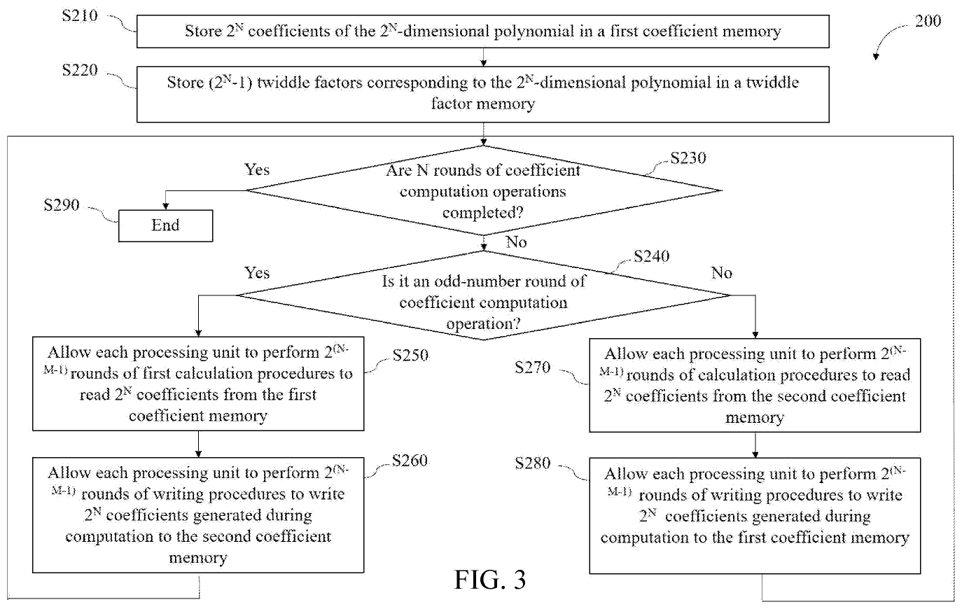

FIG. 3 is a flowchart of a calculation method 200 according to one embodiment of the present disclosure. In the present embodiment, the calculation method 200 can be applied to the calculator 100 and can include Steps S210 to S290.

In the present embodiment, Step S210 and Step S220 can be performed in an initial period before the computation operation is executed. In Step S210, the 2^{N} coefficients P[0] to P[2^{N}−1] in the 2^{N}-dimensional polynomial P1 can be stored in the first coefficient memory 110, and in Step S220, (2^{N}−1) the twiddle factors ω[1] to ω[2^{N}−1] corresponding to the 2^{N}-dimensional polynomial P1 can be stored in the twiddle factor memory 130.

During the computation, the calculator 100 may use the 2^{M} processing units to perform Steps S240 to S280 to complete the N rounds of coefficient computation operations, and then proceed to Step S290 to complete the computation after said N rounds of coefficient computation operations.

In Step S240, the calculator 100 can first determine whether the coefficient computation operation currently being performed is an odd-number round (such as the first round, the third round or the fifth round) or an even-number round (such as the second round, the fourth round or the sixth round). In Step S240, when the calculator 100 determines that the coefficient computation operation currently being performed is an odd-number round, it can then perform Step S250 and Step S260, whereas when the calculator 100 determines that the coefficient computation operation currently being performed is an even-number round, it can then perform Step S270 and Step S280.

As shown in FIG. 3, in each odd-number round of coefficient computation operation, in Step S250, the 2^{M} processing units can perform 2^{(N-M-1)} rounds of first calculation procedures in parallel to read 2^{N} first coefficients from the first coefficient memory 110, read at least one first twiddle factor from the twiddle factor memory 130, and perform modulo calculations; and in Step S260, they can perform 2^{(N-M-1)} rounds of first writing procedure in parallel to write 2^{N} first output coefficients generated during the computation to the second coefficient memory 120. Also, in each even-number round of coefficient computation operation, in Step S270, the 2^{M} processing units can perform 2^{(N-M-1)} rounds of second calculation procedures in parallel to read 2^{N} second coefficients from the second coefficient memory 120, read at least one second twiddle factor from the twiddle factor memory 130, and perform modulo calculations; and in Step S280, they can perform 2^{(N-M-1)} rounds of second writing procedure in parallel to write 2^{N} second output coefficients generated during the computation to the first coefficient memory 110.

According to the algorithm of number-theoretic transformation, the first calculation procedure in the odd-number rounds of coefficient computation operations and the second calculation procedures in the even-number rounds of coefficient computation operations may include substantially the same operations with the difference in the coefficients and twiddle factors that the two read. Further, in each round, when performing the first calculation procedure of the odd-number round of coefficient computation operation or the second calculation procedure of the even-number round of coefficient computation operation, each processing unit 140 performs the modulo calculations according to two coefficients and one twiddle factors to generate two output coefficients. In such case, to allow the 2^{M} processing units to effectively perform computations in parallel, the first coefficient memory 110 can include 2^{(M+1)} first coefficient storage blocks, and each first coefficient storage block can store 2^{(N-M-1)} coefficients. Similarly, the second coefficient memory 120 can also include 2^{(M+1)} second coefficient storage blocks, and each second coefficient storage block can store 2^{(N-M-1)} coefficients. In this way, when performing each round of first calculation procedure or second calculation procedure, each processing unit 140 can read the required coefficients from two corresponding first coefficient storage blocks or two corresponding second coefficient storage blocks.

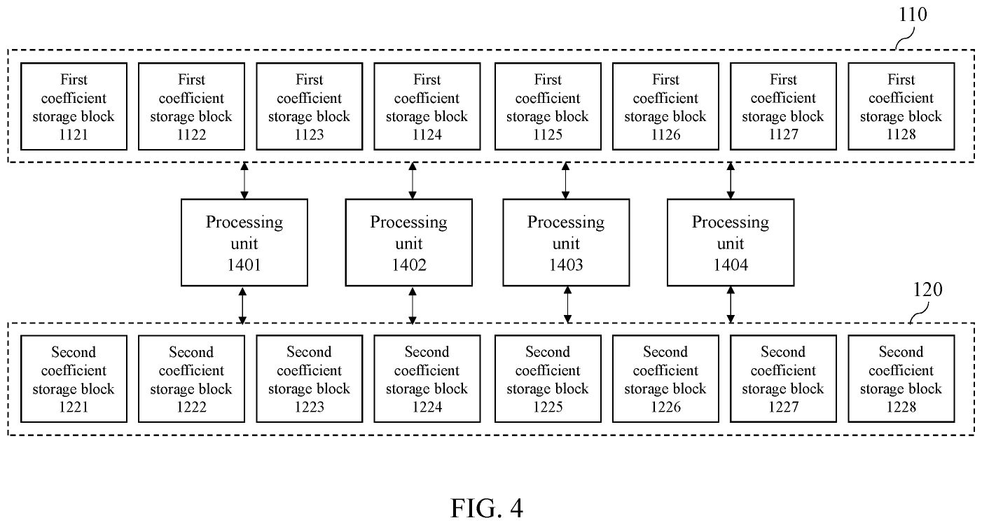

FIG. 4 shows the correspondence relationship between the processing unit 140, the first coefficient memory 110 and the second coefficient memory 120. In the embodiment of FIG. 4, N can be, for example, 5, whereas M can be, for example, 2; that is, the calculator 100 can include 4 processing units 1401, 1402, 1403 and 1404, and is configured to perform the number-theoretic transformation on a 32-dimensional polynomial P1. In such case, the first coefficient memory 110 can include 8 first coefficient storage blocks 1121, 1122, . . . , 1128, and each of the first coefficient storage blocks 1121 to 1128 can store 4 coefficients; thus, in Step S210, each of the first coefficient storage blocks 1121 to 1128 can store 4 coefficients of the 32 coefficients of the 32-dimensional polynomial P1. Similarly, the second coefficient memory 120 can include 8 second coefficient storage blocks 1221, 1222, . . . , 1228.

In such case, in each round of first calculation procedure of Step S250, each of the processing units 1401 to 1404 may respectively read one first coefficient from each of two first coefficient storage blocks of the first coefficient storage blocks 1121 to 1128, and in each round of second calculation procedure of Step S270, each of the processing units 1401 to 1404 may respectively read one first coefficient from each of two second coefficient storage blocks of the second coefficient storage blocks 1221 to 1228.

Further, in each first writing procedure of Step S260, each of the processing units 1401 to 1404 may also write two first output coefficients generated during the computation to two second coefficient storage blocks of second coefficient storage blocks 1221 to 1228, and in each second writing procedure of Step S280, each of the processing units 1401 to 1404 may then write two second output coefficients generated during the computation to two first coefficient storage blocks of the first coefficient storage blocks 1121 to 1128.

In some embodiments, in order to simplify the access operations of the processing units 1401 to 1404 on the first coefficient memory 110 and the second coefficient memory 120, the calculator 100 can store 32 coefficients P[0] to P[31] of the polynomial P1 and output coefficients generated by each round of coefficient computation operation according to a specific order. That is, in each round of first calculation procedure of Step S250, each of the processing units 1401 to 1404 may read two first coefficients from two corresponding first coefficient storage blocks according to the same address, and in each first writing procedure of Step S260, each of the processing units 1401 to 1404 can write two first output coefficients to two second coefficient storage blocks according to the same address. Similarly, in each round of second calculation procedure of Step S270, each of the processing units 1401 to 1404 may read two second coefficients from two corresponding second coefficient storage blocks according to the same address, and in each second writing procedure of Step S280, each of the processing units 1401 to 1404 can also write two second output coefficients to two first coefficient storage blocks according to the same address.

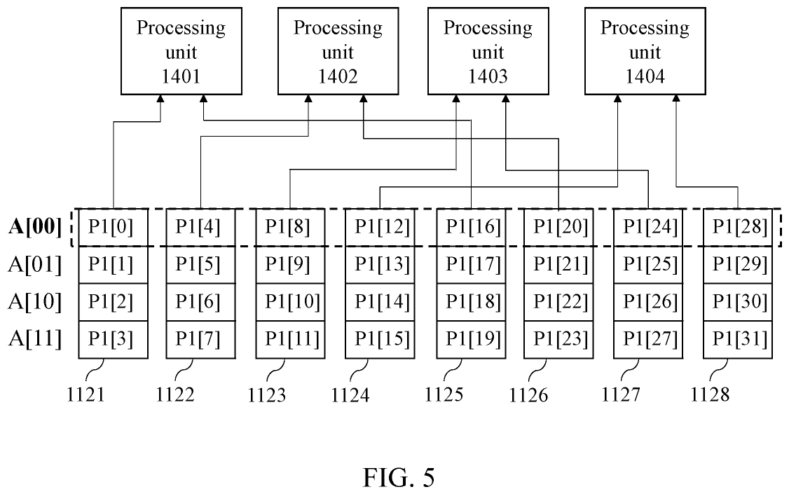

FIG. 5 to FIG. 8 are schematic diagrams respectively illustrating that, in the first to fourth rounds of first calculation procedures in Step S250, the processing units 1401 to 1404 read coefficients from the first coefficient storage blocks 1121 to 1128.

As shown in FIG. 5, when performing the first round of first calculation procedure, the processing unit 1401 can respectively read coefficients P[0] and P[16] from the address A[00] of the first coefficient storage blocks 1121 and 1125, the processing unit 1402 can respectively read coefficients P[4] and P[20] from the address A[00] of the first coefficient storage blocks 1122 and 1126, the processing unit 1403 can respectively read coefficients P[8] and P[24] from the address A[00] of first coefficient storage blocks 1123 and 1127, whereas the processing unit 1404 can respectively reads coefficients P[12] and P[28] from the address A[00] of first coefficient storage blocks 1124 and 1128.

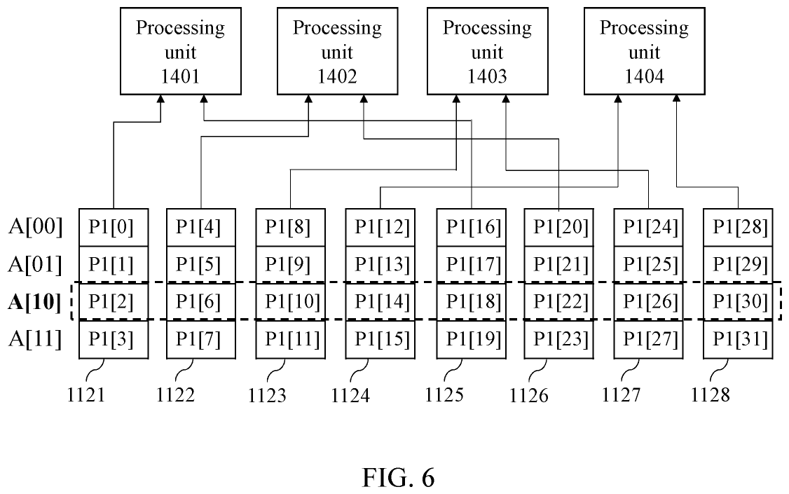

As shown in FIG. 6, when performing the second round of first calculation procedure, the processing unit 1401 can respectively read coefficients P[2] and P[18] from the address A[10] of the first coefficient storage blocks 1121 and 1125, the processing unit 1402 can respectively read coefficients P[6] and P[22] from the address A[10] of the first coefficient storage blocks 1122 and 1126, the processing unit 1403 can respectively read coefficients P[10] and P[26] from the address A[10] of the first coefficient storage blocks 1123 and 1127, whereas the processing unit 1404 can respectively read coefficients P[14] and P[30] from the address A[10] of the first coefficient storage blocks 1124 and 1128.

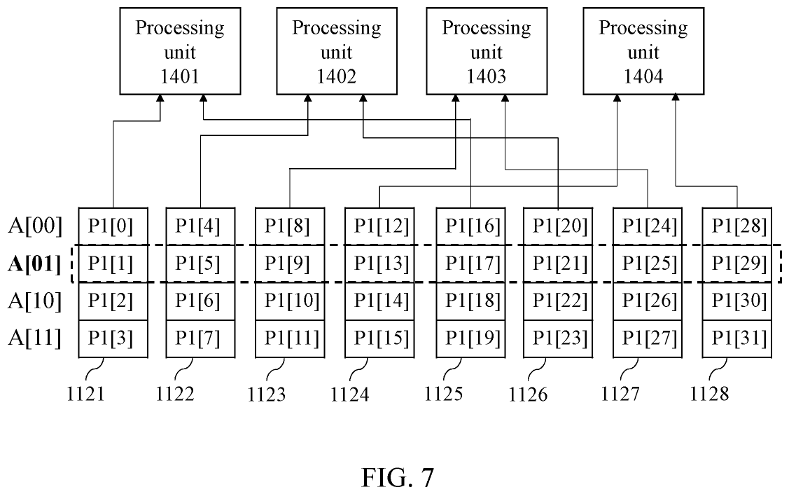

As shown in FIG. 7, when performing the third round of first calculation procedures, the processing unit 1401 can respectively read coefficients P[1] and P[17] from the address A[01] of the first coefficient storage blocks 1121 and 1125, the processing unit 1402 can respectively read coefficients P[5] and P[21] from the address A[01] of the first coefficient storage blocks 1122 and 1126, the processing unit 1403 can respectively read coefficients P[9] and P[25] from the address A[01] of the first coefficient storage blocks 1123 and 1127, whereas the processing unit 1404 can respectively read coefficients P[13] and P[29] from first the address A[01] of the first coefficient storage blocks 1124 and 1128.

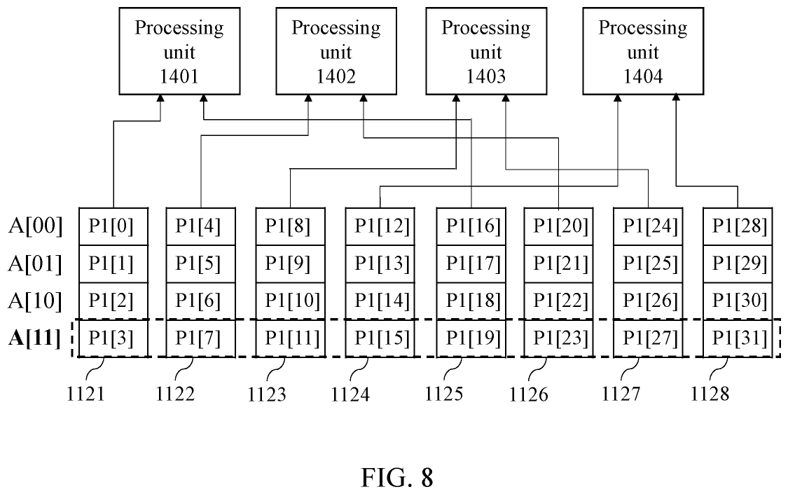

As shown in FIG. 8, when performing the fourth round of the first calculation procedures, the processing unit 1401 can respectively read coefficients P[3] and P[19] from the address A[11] of the first coefficient storage blocks 1121 and 1125, the processing unit 1402 can respectively read coefficients P[7] and P[23] from the address A[11] of the first coefficient storage blocks 1122 and 1126, the processing unit 1403 can respectively read coefficients P[11] and P[27] groom the address A[11] of the first coefficient storage blocks 1123 and 1127, whereas the processing unit 1404 can respectively read coefficients P[15] and P[31] from the address A[11] of the first coefficient storage blocks 1124 and 1128.

In some embodiments, in the first to fourth rounds of second calculation procedures in Step S270, the processing units 1401 to 1404 can also read corresponding coefficients from the second coefficient storage blocks 1221 to 1228 according to the addresses and orders shown in FIG. 5 to FIG. 8.

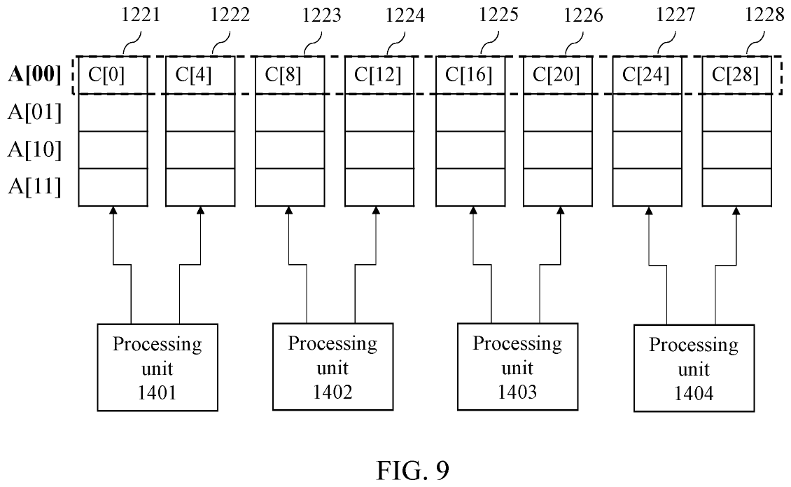

FIG. 9 to FIG. 12 are schematic diagrams respectively illustrating that, in the first to fourth rounds of first writing procedures in Step S260, the processing units 1401 to 1404 write output coefficients to second coefficient storage blocks 1221 to 1228.

As shown in FIG. 9, when performing the first round of the first writing procedure, the processing unit 1401 can respectively write the first output coefficients C[0] and C[4] generated by previous calculation to the address A[00] of the second coefficient storage blocks 1221 and 1222, the processing unit 1402 can respectively write the first output coefficients C[8] and C[12] generated by previous calculation to the address A[00] of the second coefficient storage blocks 1223 and 1224, the processing unit 1403 can respectively write the first output coefficients C[16] and C[20] generated by previous calculation to the address A[00] of the second coefficient storage blocks 1225 and 1226, and the processing unit 1404 can respectively write the first output coefficients C[24] and C[28] generated by previous calculation to the address A[00] of the second coefficient storage blocks 1227 and 1228.

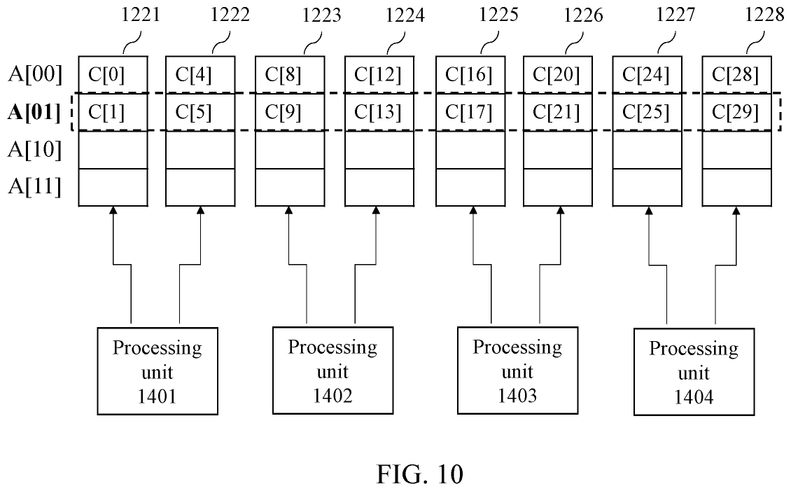

As shown in FIG. 10, when performing the second round of the first writing procedure, the processing unit 1401 can respectively write the first output coefficients C[1] and C[5] generated by previous calculation to the the address A[01] of the second coefficient storage blocks 1221 and 1222, the processing unit 1402 can respectively write the first output coefficients C[9] and C[13] generated by previous calculation to the the address A[01] of the second coefficient storage blocks 1223 and 1224, the processing unit 1403 can respectively write the first output coefficients C[17] and C[21] generated by previous calculation to the address A[1] of the second coefficient storage blocks 1225 and 1226, and the processing unit 1404 can respectively write the first output coefficients C[25] and C[29] generated by previous calculation to the address A[01] of the second coefficient storage blocks 1227 and 1228.

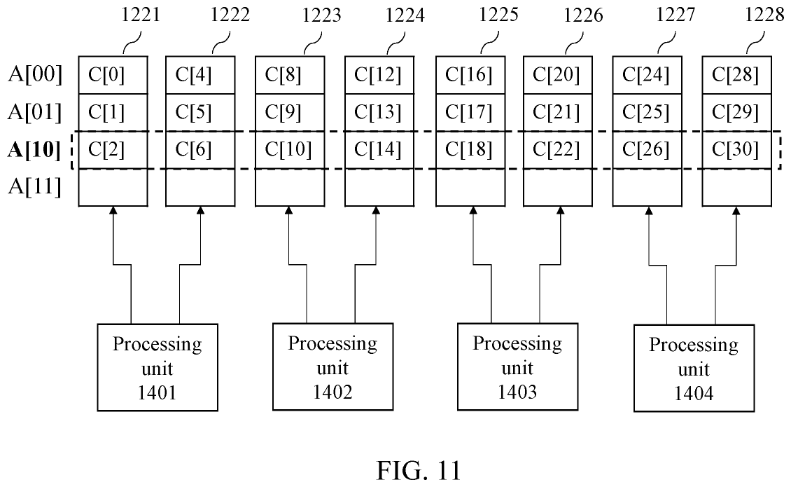

As shown in FIG. 11, when performing the third round of the first writing procedure, the processing unit 1401 can respectively write the first output coefficients C[2] and C[6] generated by previous calculation to the the address A[10] of the second coefficient storage blocks 1221 and 1222, the processing unit 1402 can respectively write the first output coefficients C[10] and C[14] generated by previous calculation to the the address A[10] of the second coefficient storage blocks 1223 and 1224, the processing unit 1403 can respectively write the first output coefficients C[18] and C[22] generated by previous calculation to the address A[10] of the second coefficient storage blocks 1225 and 1226, and the processing unit 1404 can respectively write the first output coefficients C[26] and C[30] generated by previous calculation to the address A[10] of the second coefficient storage blocks 1227 and 1228.

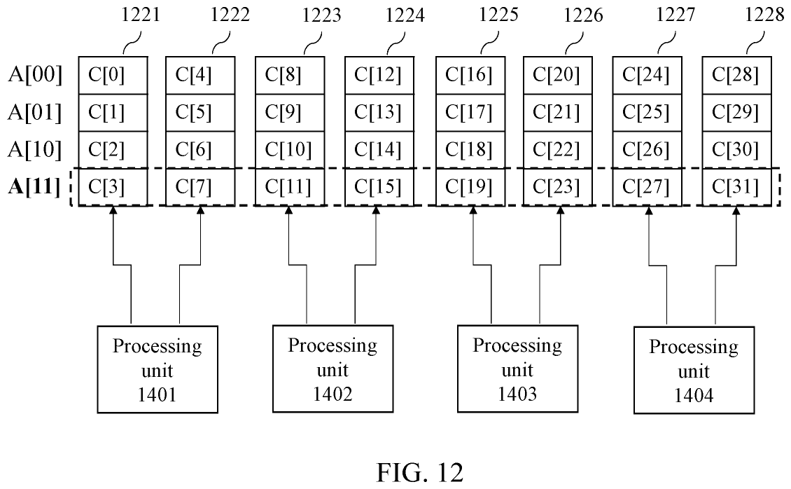

As shown in FIG. 12, when performing the fourth round of the first writing procedure, the processing unit 1401 can respectively write the first output coefficients C[3] and C[7] generated by previous calculation to the the address A[11] of the second coefficient storage blocks 1221 and 1222, the processing unit 1402 can respectively write the first output coefficients C[11] and C[15] generated by previous calculation to the the address A[11] of the second coefficient storage blocks 1223 and 1224, the processing unit 1403 can respectively write the first output coefficients C[19] and C[23] generated by previous calculation to the address A[11] of the second coefficient storage blocks 1225 and 1226, and the processing unit 1404 can respectively write the first output coefficients C[27] and C[31] generated by previous calculation to the address A[11] of the second coefficient storage blocks 1227 and 1228.

In some embodiments, in the first to fourth rounds of second writing procedures in Step S280, the processing units 1401 to 1404 can also write two second output coefficients in the first coefficient storage blocks 1121 to 1128 according to the addresses and orders shown in FIG. 9 to FIG. 12.

Further, as shown in FIG. 5 to FIG. 12, in the present embodiment, each of the processing units 1401 to 1404 may access two predetermined first coefficient storage blocks and two predetermined second coefficient storage blocks. For example, the processing unit 1401, in each round of first calculation procedure, may constantly read coefficients from first coefficient storage blocks 1121 and 1125, and, in each first writing procedure, constantly write output coefficients to second coefficient storage blocks 1221 and 1222. Similarly, the processing unit 1401 can, in each round of second calculation procedure, constantly read coefficients from second coefficient storage blocks 1221 and 1225, and in each second writing procedure, constantly write output coefficients to first coefficient storage blocks 1121 and 1122. In such case, each of the processing units 1401 to 1404 only needs to be coupled to few certain coefficient storage blocks, and is not required to be coupled to all of the coefficient storage blocks 1121 to 1128 and 1221 to 1228, thereby simplifying the complexity of the wirings inside the calculator 100.

Further, as shown in FIG. 5 to FIG. 12, in each round of first calculation procedure, the processing units 1401 to 1404 can read the first coefficient storage blocks 1121 to 1128 according to the same address, and in each first writing procedure, the processing units 1401 to 1404 can read second coefficient storage blocks 1221 to 1228 according to the same address. In such case, the first coefficient storage blocks 1121 to 1128 can receive a same address signal, and second coefficient storage blocks 1221 to 1228 can also receive a same address signal. In some embodiments, the address terminals of the first coefficient storage blocks 1121 to 1128 can be coupled to the same address line, and the address terminals of second coefficient storage blocks 1221 to 1228 can also be coupled to the same address line, thereby simplifying the complexity of the wirings inside the calculator 100.

In the present embodiment, in addition to accessing the first coefficient memory 110 and the second coefficient memory 120 according to a specific order to simplify the wiring connections between 2^{M} processing units 140 and the first coefficient memory 110 and the second coefficient memory 120 and reducing the operational complexity, the calculator 100 can also store the the twiddle factors ω[1] to ω[2^{N}−1] required for the number-theoretic transformation algorithm according to a specific order.

According to the number-theoretic transformation algorithm of FIG. 2, the number of twiddle factors used in each coefficient computation operation is twice the number of the twiddle factors used in the previous coefficient computation operation; however, the calculator 100 can only use 2^{M} processing units 140 at most to perform modulo calculations in parallel at the same time; that is, the calculator 100 can only use 2^{M} twiddle factors at the same time at most. Therefore, in the present embodiment, the twiddle factor memory 130 can include the same number of twiddle factor storage blocks as the number of the processing units 140.

Further, when the number of twiddle factors required for a specific round of coefficient computation operation is not greater than the total number of rounds (that is, 2^{(N-M-1)} rounds) of calculation procedures to be performed in each coefficient computation operation, the 2^{M} processing units 140 may use one single twiddle factor in each round of first calculation procedures or second calculation procedure, whereas different twiddle factors can be used in different rounds of first calculation procedures or second calculation procedures. In such case, the 2^{M} processing units 140 can still read corresponding twiddle factors from the same twiddle factor storage block.

However, when the number of twiddle factors required for one coefficient computation operation is greater than the total number of rounds (that is, 2^{(N-M-1)} rounds) of calculation procedures to be performed in each coefficient computation operation, different processing units 140 may simultaneously use different twiddle factors in each calculation procedure to perform modulo calculations so as to maintain the performance of parallel computation; in such case, because each twiddle factor storage block has only one read/write terminal, the 2^{M} processing units 140 must read the required twiddle factors from different twiddle factor storage blocks.

In such case, to maintain the performance of the parallel computation of the processing units 140 and hardware usage rate of the twiddle factor memory 130, the twiddle factor memory 130 can have 2^{M} twiddle factor storage blocks, which include a first twiddle factor storage block for storing (2^{(N-M})−1+2^{(N-M-1)}×M) twiddle factors, and 2^{(M-i)}i^{th} twiddle factor storage blocks for storing (2^{(N-M-1)}×i) twiddle factors, wherein i is an integer between 1 and M. In this way, in the first (N−M) rounds of coefficient computation operations of the N rounds of coefficient computation operations, the 2^{M} processing units 140 can read at least one twiddle factor from the first twiddle factor storage block, whereas in the last k rounds of coefficient computation operations of the N rounds of coefficient computation operations, the 2^{M} processing units 140 can read 2^{(N-K)} twiddle factors from the 2^{(M-K+1)} twiddle factor storages blocks of the 2^{M} twiddle factor storage blocks, wherein k is an integer between 1 and M.

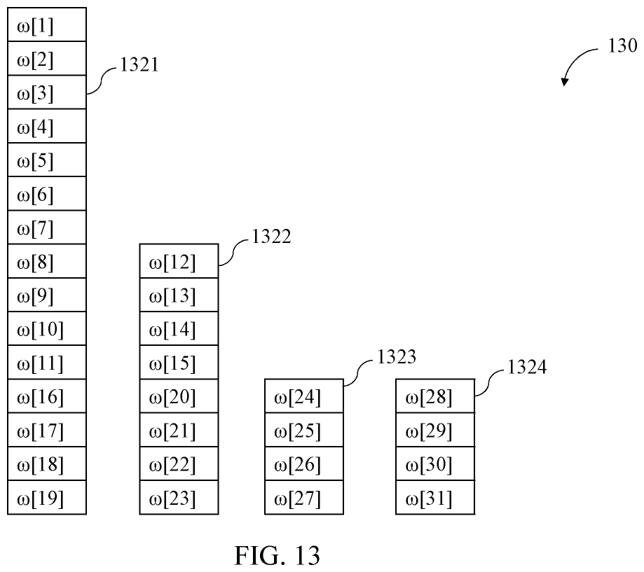

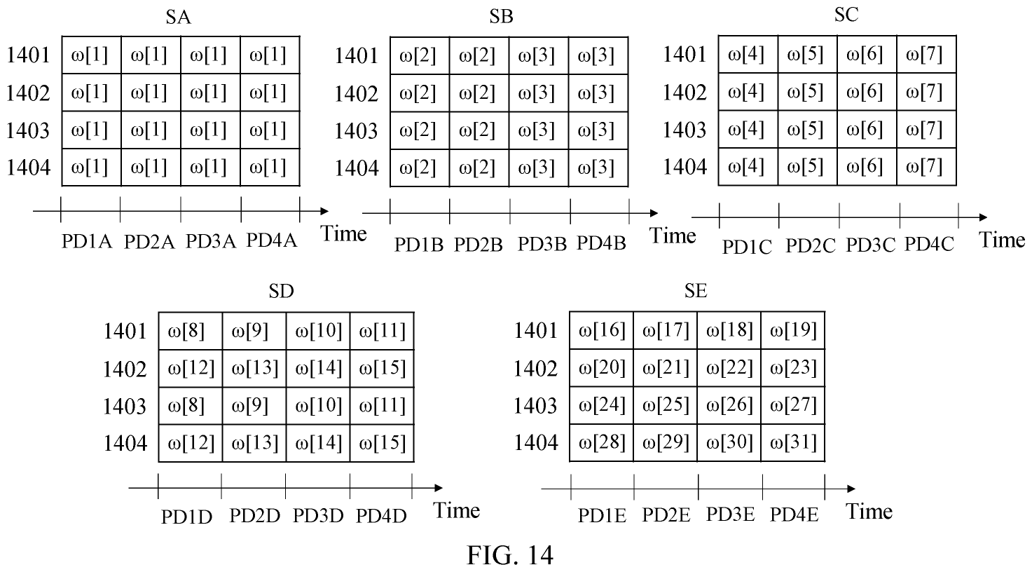

FIG. 13 is a schematic diagram illustrating the twiddle factor memory 130 according to one embodiment of the present disclosure; FIG. 14 illustrates a sequence of the processing units 1401 to 1404 reading twiddle factors from the twiddle factor memory 130. In the embodiment of FIG. 13, M is 2, N is 5; thus, the twiddle factor memory 130 can include 4 twiddle factor storage blocks 1321, 1322, 1323 and 1324, wherein the first twiddle factor storage blocks 1321 is configured to store 15 twiddle factors, the second twiddle factor storage blocks 1322 is configured to store 8 twiddle factors, and each of the the third twiddle factor storage blocks 1323 and 1324 is configured to store 4 twiddle factors.

In such case, as shown in FIG. 14, in the first coefficient computation operation SA, since only one twiddle factor is required, in the four rounds of first calculation procedures PD1A, PD2A, PD3A and PD4A of the first coefficient computation operation SA, the processing units 1401 to 1404 can read the twiddle factor ω[1] from twiddle factor storage block 1321.

In the second coefficient computation operation SB, since only two twiddle factors are required, in the first calculation procedures PD1B and PD2B of the second coefficient computation operation SB, the processing units 1401 to 1404 can read the twiddle factor ω[2] from the twiddle factor storage block 1321, and in the first calculation procedures PD3B and PD4B, the processing units 1401 to 1404 can read the twiddle factor ω[3] from the twiddle factor storage block 1321, and so on so forth. Accordingly, in the four rounds of first calculation procedures PD1C, PD2C, PD3C and PD4C of the third coefficient computation operation SC, the processing units 1401 to 1404 can sequentially read twiddle factors ω[4], ω[5], ω[6] and ω[7] from the twiddle factor storage blocks 1321.

Next, in the fourth coefficient computation operation SD, since the number of required twiddle factors exceeds the total number 2^{(N-M-1)} of the calculation procedure required to be performed in each coefficient computation operation; that is, the number of the required twiddle factors is greater than 4, in the four rounds of first calculation procedures PD1D, PD2D, PD3D and PD4D of the fourth coefficient computation operation SD, the processing units 1401 and 1403 can sequentially read twiddle factors ω[8], ω[9], ω[10] and ω[11] from the twiddle factor storage block 1321, whereas the processing units 1402 and 1404 can sequentially read twiddle factors ω[12], ω[13], ω[14] and ω[15] from the twiddle factor storage block 1322.

Lastly, in the four rounds of first calculation procedures PD1E, PD2E, PD3E and PD4E of the fifth coefficient computation operation SE, the processing unit 1401 can sequentially read twiddle factors ω[16], ω[17], ω[18] and ω[19] from the twiddle factor storage block 1321, the processing unit 1402 can sequentially read twiddle factors ω[20], ω[21], ω[22] and ω[23] from the twiddle factor storage block 1322, the processing unit 1403 can sequentially read twiddle factors ω[24], ω[25], ω[26] and ω[27] from the twiddle factor storage block 1323, whereas the processing unit 1404 can sequentially read twiddle factors ω[28], ω[29], ω[30] and ω[31] from the twiddle factor storage block 1324.

As a result, the parallel computation performance of the processing unit 140 can be maintained without unnecessarily increase the capacity of the twiddle factor memory 130.

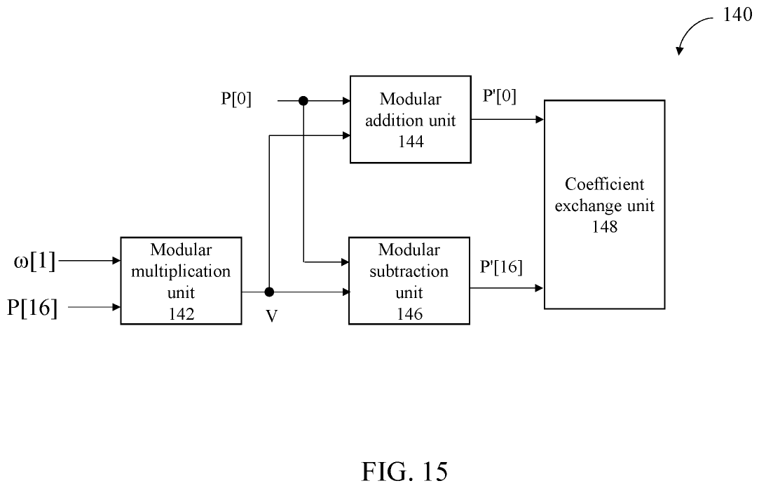

Further, in each round of calculation procedure in Step S250 and 270, each of the processing units 1401 to 1404 may perform the calculation in the third layer of the for-loop as shown in FIG. 2. FIG. 15 is a schematic diagram illustrating the processing unit 1401 according to one embodiment of the present disclosure. In the present embodiment, the processing units 1402 to 1404 can have the same structure and operate according to the same principles as the processing unit 1401.

As shown in FIG. 15, the processing unit 1401 can include a modular multiplication unit 142, a modular addition unit 144, a modular subtraction unit 146 and a coefficient exchange unit 148. In the present embodiment, when performing the first calculation procedure, the processing unit 1401 can read two first coefficients from the first coefficient storage blocks 1121 and 1125 of the first coefficient memory 110 and read a corresponding first twiddle factor from the twiddle factor memory 130, and then use the modular multiplication unit 142, the modular addition unit 144 and the modular subtraction unit 146 to perform the modulo calculation in the third layer of the for-loop as shown in FIG. 2.

For example, in the first calculation procedure of the first round of coefficient computation operation, the processing unit 1401 can read two first coefficients P[0] and P[16] from the first coefficient storage blocks 1121 and 1125 and can read the corresponding first twiddle factor ω[1] from the twiddle factor memory 130. The modular multiplication unit 142 can perform a modular multiplication calculation on the first coefficient P[16] and the first twiddle factors ω[1] according to a predetermined modulus q to generate a first value V. Next, the modular addition unit 144 can perform a modular addition calculation on the first coefficient P[0] and the first value V according to the predetermined modulus q to generate a first to-be-arranged coefficient P′[16], whereas the modular subtraction unit 146 can perform a modular subtraction calculation on the first coefficient P[0] and the first value V according to the predetermined modulus q to generate a second to-be-arranged coefficient P′[0].

In the present embodiment, the processing unit 1401 may not directly perform the first writing procedure after generating the to-be-arranged coefficients P′[0] and P′[16] and directly write the to-be-arranged coefficientz P′[0] and P′[16] in the second coefficient memory 120, in order to maintain the order of storing each coefficient in the second coefficient memory 120 so that in the calculation procedures of the second round of coefficient computation operation, the processing units 1401 to 1404 can still read coefficients from the second coefficient memory 120 according to the addresses and order shown in FIG. 5 to FIG. 8. In such case, the processing unit 1401 may rearrange the output order of a plurality of first to-be-arranged coefficients generated by the modular addition unit 144 and a plurality of second to-be-arranged coefficients generated by the modular subtraction unit 146 with the coefficient exchange unit 148 to perform the subsequent first writing procedures.

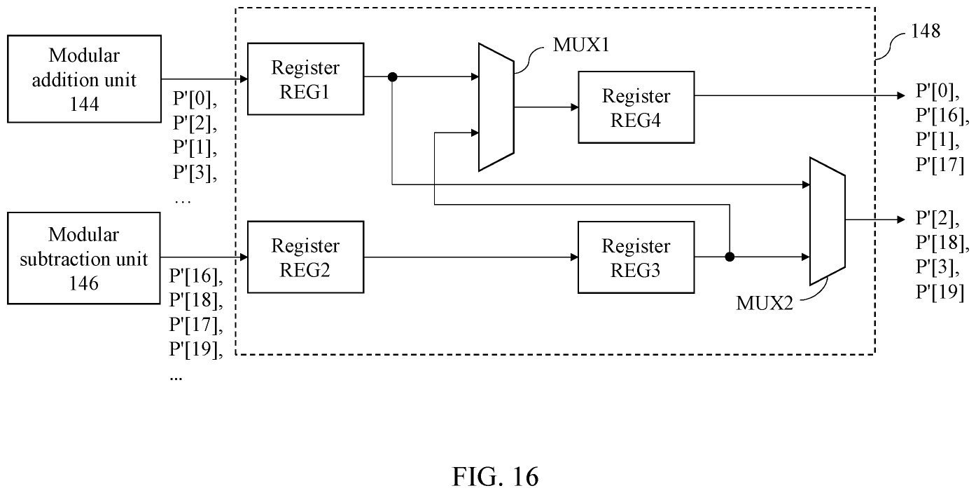

FIG. 16 is a schematic diagram illustrating the coefficient exchange unit 148 according to one embodiment of the present disclosure. The coefficient exchange unit 148 includes registers REG1, REG2, REG3 and REG4 and multiplexers MUX1 and MUX2. The register REG1 has an input terminal and an output terminal, wherein the input terminal of the first register the register REG1 is coupled to the modular addition unit 144. The register REG2 has an input terminal and an output terminal, wherein the input terminal of the register REG2 is coupled to the modular subtraction unit 146. The register REG3 has an input terminal and an output terminal, wherein the input terminal of the register REG3 is coupled to an output terminal the register REG2. The multiplexer MUX1 has a first input terminal, a second input terminal and an output terminal, wherein the first input terminal of the multiplexer MUX is coupled to the output terminal of the register REG1, whereas the second input terminal of the multiplexer MUX1 is coupled to the output terminal of the register REG3. The register REG4 has an input terminal and an output terminal, wherein the input terminal of the register REG4 is coupled to the output terminal of the multiplexer MUX1, whereas the output terminal of the register REG4 is configured to output the first arranged output coefficient. The multiplexer MUX2 has a first input terminal, a second input terminal and an output terminal, wherein the first input terminal of the multiplexer MUX2 is coupled to the output terminal of the register REG1, the second input terminal of the multiplexer MUX2 is coupled to the output terminal of the register REG3, whereas the output terminal of the multiplexer MUX2 is configured to output the second arranged output coefficient.

In the present embodiment, the multiplexer MUX1 alternately outputs data received by the first input terminal of multiplexer MUX1 and data received by the second input terminal of multiplexer MUX1. Further, when the multiplexer MUX1 outputs the data received by the first input terminal of the multiplexer MUX1, the multiplexer MUX2 may output the data received by the second input terminal of the multiplexer MUX2; when the multiplexer MUX1 outputs the data received by the second input terminal of the multiplexer MUX1, the multiplexer MUX2 may output the data received by the first input terminal of the multiplexer MUX2.

In such case, the coefficient exchange unit 148 may alternately output the to-be-arranged coefficients obtained by calculation in the calculation procedure by the processing unit 1401. For example, if the processing unit 1401 follows the order shown in FIG. 5 to FIG. 8 and generate to-be-arranged coefficients P′[0], P′[16] according to coefficients P[0] and P[16], generate to-be-arranged coefficients P′[2], P′[18] according to coefficients P[2] and P[18], generate to-be-arranged coefficients P′[1], P′[17] according to coefficients P[1] and P[17], and generate to-be-arranged coefficients P′[3], P′[19] according to coefficients P[3] and P[19] respectively in four rounds of first calculation procedures of the first coefficient computation operation, then after the coefficient exchange unit 148 rearranges the output order of the to-be-arranged coefficients generated in the calculation procedure, in the four rounds of first writing procedure of the first coefficient computation operation, the processing unit 1401 may follow the order shown in FIG. 9 to FIG. 12, and write the to-be-arranged coefficients P′[0] and P′[2] as the first output coefficients C[0] and C[4] in the second coefficient storage blocks 1221 and 1222, write the to-be-arranged coefficients P′[16] and P′[18] as the first output coefficients C[1] and C[5] in the second coefficient storage blocks 1221 and 1222, write the to-be-arranged coefficients P′[1] and P′[3] as the first output coefficients C[2] and C[6] in the second coefficient storage blocks 1221 and 1222, and write the to-be-arranged coefficients P′[17] and P′[19] as the first output coefficients C[3] and C[7] in the second coefficient storage blocks 1221 and 1222.

As a result, in the second round of coefficient computation operation, the processing unit 1401 can follow the same addresses and order according to FIG. 5 to FIG. 8, and obtain the coefficients required for modulo calculation from second coefficient storage blocks 1221 and 1225.

In other words, the processing units 1401 to 1404 can rearrange the order of output coefficients with the coefficient exchange unit 148, such that in each calculation procedure, the processing units 1401 to 1404 can obtain corresponding coefficients from the first coefficient memory 110 or the second coefficient memory 120 according to the addresses and order of FIG. 5 to FIG. 8 to perform modulo calculation, and write data in the first coefficient memory 110 or the second coefficient memory 120 according to the addresses and order of FIG. 9 to FIG. 12. However, the present application is not limited thereto, in some other embodiments, the processing units 1401 to 1404 can also read from or write in the first coefficient memory 110 or the second coefficient memory 120 according to an order different from that shown in FIG. 5 to FIG. 12, and can correspondingly change the design of the coefficient exchange unit 148 to allow the processing units 1401 to 1404 to access the first coefficient memory 110 or the second coefficient memory 120 according to the same order and addresses in each coefficient computation operation.

In view of the foregoing, the calculator and calculation method of the present disclosure can perform modulo calculations of number-theoretic transformation using multiple processing units in parallel, and can access the data in two coefficient memories according to a specific order, thereby simplifying the wirings between the processing units and coefficient memories and improving the overall computation performance thereof.

The foregoing description briefly sets forth the features of some embodiments of the present application so that persons having ordinary skill in the art more fully understand the various aspects of the disclosure of the present application. It may be apparent to those having ordinary skill in the art that they can easily use the disclosure of the present application as a basis for designing or modifying other processes and structures to achieve the same purposes and/or benefits as the embodiments herein. It should be understood by those having ordinary skill in the art that these equivalent implementations still fall within the spirit and scope of the disclosure of the present application and that they may be subject to various variations, substitutions, and alterations without departing from the spirit and scope of the present disclosure.

What is claimed is:

1. A calculator, configured to perform number-theoretic transformation on a 2^{N}-dimensional polynomial, wherein N is an integer greater than 1, and the calculator comprises:
a first coefficient memory, configured to store 2^{N} coefficients of the 2^{N}-dimensional polynomial in an initial period;
a second coefficient memory;
a twiddle factor memory, configured to store (2^{N}−1) twiddle factors;
2^{M} processing units, configured to perform N rounds of coefficient computation operations in parallel, wherein M is an integer greater than 1 and smaller than N; and
a data flow controller, configured to control access addresses of the 2^{M} processing units for accessing the first coefficient memory, the second coefficient memory and the twiddle factor memory;
wherein:
in each odd-number round of the N rounds of coefficient computation operations:
the 2^{M} processing units perform 2^{(N-M-1)} rounds of first calculation procedures to read 2^{N} first coefficients from the first coefficient memory, read at least one first twiddle factor from the twiddle factor memory, and perform a modulo calculation; and
the 2^{M} processing units perform 2^{(N-M-1)} rounds of first writing procedures to write 2^{N} first output coefficients generated during computation to the second coefficient memory; and
in each even-number round of the N rounds of coefficient computation operations:
the 2^{M} processing units perform 2^{(N-M-1)} rounds of second calculation procedures to read 2^{N} second coefficients from the second coefficient memory, read at least one second twiddle factor from the twiddle factor memory, and perform a modulo calculation; and
the 2^{M} processing units perform 2^{(N-M-1)} rounds of second writing procedures to write 2^{N} second output coefficients generated during computation to the first coefficient memory.

2. The calculator of claim 1, wherein:
the first coefficient memory comprises 2^{(M+1)} first coefficient storage blocks each configured to store 2^{(N-M-1)} coefficients; and
the second coefficient memory comprising 2^{(M+1)} second coefficient storage blocks each configured to store 2^{(N-M-1)} coefficients.

3. The calculator of claim 2, wherein:
in each round of the first calculation procedures, each processing unit reads a first coefficient from each of two first coefficient storage blocks of the 2^{(M+1)} first coefficient storage blocks; and
in each round of the second calculation procedures, each processing unit reads a second coefficient from each of two second coefficient storage blocks of the 2^{(M+1)} second coefficient storage blocks.

4. The calculator of claim 3, wherein:
in each round of first calculation procedure, each processing unit reads the one first coefficient from each of the two first coefficient storage blocks according to a same address; and
in each round of second calculation procedure, each processing unit reads the one second coefficient from each of the two second coefficient storage blocks according to a same address.

5. The calculator of claim 2, wherein:
in each round of first writing procedure, each processing unit writes two first output coefficients generated during computation to two second coefficient storage blocks of the 2^{(M+1)} second coefficient storage blocks; and
in each round of second calculation procedure, each processing unit writes two second output coefficients generated during computation to two first coefficient storage blocks of the 2^{(M+1)} first coefficient storage blocks.

6. The calculator of claim 5, wherein:
in each round of first calculation procedure, each processing unit writes the two first output coefficients to the two second coefficient storage blocks according to the same address; and
in each round of second calculation procedure, each processing unit writes the two second output coefficients to the two first coefficient storage blocks according to a same address.

7. The calculator of claim 1, wherein:
in each round of first calculation procedure, each processing unit performs a modulo calculation according to the two first coefficients read from the first coefficient memory and a first twiddle factor read from the twiddle factor memory; and
in each round of second calculation procedure, each processing unit performs a modulo calculation according to the two second coefficients read from the second coefficient memory read and a second twiddle factor read from the twiddle factor memory.

8. The calculator of claim 7, wherein a first processing unit of the 2^{M} processing units comprises:
a modular multiplication unit, configured to perform a modular multiplication calculation on one of the two first coefficients according to a predetermined modulus and the first twiddle factors to generate a first value;
a modular addition unit, configured to perform a modular addition calculation on the other of the two first coefficients according to the predetermined modulus and the first value to generate a first to-be-arranged coefficient;
a modular subtraction unit, configured to perform a modular subtraction calculation on the other of the two first coefficients and the first value according to the predetermined modulus to generate a second to-be-arranged coefficient; and
a coefficient exchange unit, configured to rearrange an output order of a plurality of first to-be-arranged coefficients generated by the modular addition unit and a plurality of second to-be-arranged coefficients generated by the modular subtraction unit for performing a plurality of subsequent first writing procedures.

9. The calculator of claim 8, wherein the coefficient exchange unit comprises:
a first register, having an input terminal and an output terminal, wherein the input terminal of the first register is coupled to the modular addition unit;
a second register, having an input terminal and an output terminal, wherein the input terminal of the second register is coupled to the modular subtraction unit;
a third register, having an input terminal and an output terminal, wherein the input terminal of the third register is coupled to the output terminal of the second register;
a first multiplexer, having a first input terminal, a second input terminal and an output terminal, wherein the first input terminal of the first multiplexer is coupled to the output terminal of the first register, and the second input terminal of the first multiplexer is coupled to the output terminal of the third register;
a fourth register, having an input terminal and an output terminal, wherein the input terminal of the fourth register is coupled to the output terminal of the first multiplexer, and the output terminal of the fourth register is configured to output a first arranged output coefficient; and
a second multiplexer, having a first input terminal, a second input terminal and an output terminal, wherein the first input terminal of the second multiplexer is coupled to the output terminal of the first register, the second input terminal of the second multiplexer is coupled to the output terminal of the third register, and the output terminal of the second multiplexer is configured to output a second arranged output coefficient;
wherein:
the first multiplexer alternately outputs data received by the first input terminal and the second input terminal of the first multiplexer;
when the first multiplexer outputs data received by the first input terminal of the first multiplexer, the second multiplexer outputs data received by the second input terminal of the second multiplexer; and
when the first multiplexer outputs data received by the second input terminal of the first multiplexer, the second multiplexer outputs data received by the first input terminal of the second multiplexer.

10. The calculator of claim 1, wherein the twiddle factor memory comprises 2^{M} twiddle factor storage blocks, wherein the 2^{M} twiddle factor storage blocks comprise a first twiddle factor storage block configured to store (2^{(N-M)}−1+2^{(N-M-1)}×M) twiddle factors, and 2^{(M-i)}i^{th} twiddle factor storage blocks configured to store (2^{(N-M-1)}×i) twiddle factors, wherein i is an integer between 1 and M.

11. The calculator of claim 10, wherein, in the first (N−M) rounds of coefficient computation operations of the N rounds of coefficient computation operations, the 2^{M} processing units read at least one twiddle factor from the first twiddle factor storage blocks, and in the last k rounds of coefficient computation operations of the N rounds of coefficient computation operations, the 2^{M} processing units blocks read 2^{(N-K)} twiddle factors from 2^{(M-K+1)} twiddle factor storages of the 2^{M} twiddle factor storage blocks, wherein k is an integer between 1 and M.

12. A calculation method, wherein, configured to perform a number-theoretic transformation on a 2^{N}-dimensional polynomial, and the method comprises:
in an initial period:
storing 2^{N} coefficients of the 2^{N}-dimensional polynomial in a first coefficient memory; and
storing (2^{N}−1) twiddle factors corresponding to the 2^{N}-dimensional polynomial in a twiddle factor memory;
in a computation period, using 2^{M} processing units to perform N rounds of coefficient computation operations in parallel, comprising:
in each odd-number round of the N rounds of coefficient computation operations:
allowing the 2^{M} processing units to perform 2^{(N-M-1)} rounds of first calculation procedures to read 2^{N} first coefficients from the first coefficient memory, read at least one first twiddle factor from the twiddle factor memory, and perform modulo calculation; and
allowing the 2^{M} processing units to perform 2^{(N-M-1)} rounds of first writing procedures to write 2^{N} first output coefficients generated during computation to the second coefficient memory; and
in each even-number round of the N rounds of coefficient computation operations:
allowing the 2^{M} processing units to perform 2^{(N-M-1)} rounds of second calculation procedures to read 2^{N} second coefficients from the second coefficient memory, read at least one second twiddle factor from the twiddle factor memory, and perform a modulo calculation; and
allowing the 2^{M} processing units to perform 2^{(N-M-1)} rounds of second writing procedures to write 2^{N} second output coefficients generated during computation to the first coefficient memory;
wherein N is an integer greater than 1, and M is an integer greater than 1 and smaller than N.

13. The method of claim 12, wherein:
the first coefficient memory comprises 2^{(M+1)} first coefficient storage blocks, and the second coefficient memory comprises 2^{(M+1)} second coefficient storage blocks; and
the step of storing the 2^{N} coefficients of the 2^{N}-dimensional polynomial in the first coefficient memory comprises allowing the 2^{(M+1)} first coefficient storage blocks to respectively store 2^{(N-M-1)} coefficients.

14. The method of claim 13, wherein:
the step of allowing the 2^{M} processing units to perform the 2^{(N-M-1)} rounds of first calculation procedures comprises, in each round of first calculation procedure, allowing each processing unit to read a first coefficient from each of two first coefficient storage blocks of the 2^{(M+1)} first coefficient storage blocks; and
the step of allowing the 2^{M} processing units to perform the 2^{(N-M-1)} rounds of second calculation procedure comprises, in each round of second calculation procedure, allowing each processing unit to read a second coefficient from each of two second coefficient storage blocks of the 2^{(M+1)} second coefficient storage blocks.

15. The method of claim 14, wherein:
in each round of first calculation procedure, each processing unit reads the one first coefficient from each of the two first coefficient storage blocks according to a same address; and
in each round of second calculation procedure, each processing unit reads the one second coefficient from each of the two second coefficient storage blocks according to a same address.

16. The method of claim 13, wherein:
the step of allowing the 2^{M} processing units to perform the 2^{(N-M-1)} rounds of first writing procedures comprises, in each round of first writing procedure, allowing each processing unit to write two first output coefficients generated during computation to two second coefficient storage blocks of the 2^{(M+1)} second coefficient storage blocks; and
the step of allowing the 2^{M} processing units to perform the 2^{(N-M-1)} rounds of second writing procedures comprises, in each round of second calculation procedure, allowing each processing unit to write two second output coefficients generated during computation to two first coefficient storage blocks of the 2^{(M+1)} first coefficient storage blocks.

17. The method of claim 13, wherein:
in each round of first calculation procedure, each processing unit writes the two first output coefficients to the two second coefficient storage blocks according to a same address; and
in each round of second calculation procedure, each processing unit writes the two second output coefficients to the two first coefficient storage blocks according to a same address.

18. The method of claim 12, wherein:
the step of allowing the 2^{M} processing units to perform the 2^{(N-M-1)} rounds of first calculation procedures comprises, in each round of first calculation procedure, allowing each processing unit to perform a modulo calculation according to two first coefficients read from the first coefficient memory and a first twiddle factor read from the twiddle factor memory; and
the step of allowing the 2^{M} processing units to perform the 2^{(N-M-1)} rounds of second calculation procedures comprises, in each round of second calculation procedure, allowing each processing unit to perform a modulo calculation according to two second coefficients read from the second coefficient memory and a second twiddle factor read from the twiddle factor memory.

19. The method of claim 18, wherein, the step of allowing each processing unit to perform the modulo calculation according to the two first coefficients read from the first coefficient memory and the at least one first twiddle factor read from the twiddle factor memory comprises:
performing a modular multiplication calculation on one of the two first coefficients and the first twiddle factors according to a predetermined modulus to generate a first value;
performing a modular addition calculation on the other of the two first coefficients and the first value according to the predetermined modulus to generate a first to-be-arranged coefficient; and
performing a modular subtraction calculation on the other of the two first coefficients and the first value according to the predetermined modulus to generate a second to-be-arranged coefficient;
the method further comprises:
rearranging an output order of a plurality of first to-be-arranged coefficients and a plurality of second to-be-arranged coefficients generated during a plurality of calculation procedures of each processing unit to perform a plurality of subsequent first writing procedures.

20. The method of claim 12, wherein the twiddle factor memory comprises 2^{M} twiddle factor storage blocks, and the step of storing the (2^{N}−1) twiddle factors corresponding to the 2^{N}-dimensional polynomial to the twiddle factor memory comprises:
storing (2^{(N-M)}−1+2^{(N-M-1)}×M) twiddle factors in first twiddle factor storage blocks of the 2^{M} twiddle factor storage blocks; and
storing (2^{(N-M-1)}×i) twiddle factors in the i^{th} twiddle factor storage block of the 2^{(M-i)} twiddle factor storage blocks, wherein i is an integer between 1 and M.
